(19) United States
(12) Patent Application Publication
(10) Pub. No.: US 2007/0282801 A1
(43) Pub. Date: Dec. 6, 2007

(54) DYNAMICALLY CREATING AND EXECUTING AN APPLICATION LIFECYCLE MANAGEMENT OPERATION

(76) Inventors: AJAY A APTE, Austn, TX (US); Fong-Meng L.L. Chan, Austin, TX (US); Truong-An H. Thai, Pflugerville, TX (US); Brain Tsai, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/422,255

(22) Filed: Jun. 5, 2006

(51) Int. Cl. G06F 17/30

(52) U.S. Cl. 707/3

(57) ABSTRACT

Methods, systems, and computer program products are provided for dynamically creating and executing an application lifecycle management operation. Embodiments include receiving a packaged application for lifecycle management and an instruction to perform a lifecycle management operation; querying a plurality of plug-ins for steps to carry out a plurality of aspects of the management operation on the packaged application; receiving from one or more of the queried plug-ins steps to carry out a plurality of aspects of the management operation; and executing the steps.

### BACKGROUND OF THE INVENTION

1. Field of the Invention

The field of the invention is data processing, or, more specifically, methods, systems, and products for dynamically creating and executing an application lifecycle management operation.

2. Description Of Related Art

In the lifecycle of an application, such as a business application running on a server platform, various lifecycle management operations are performed on the application in its lifecycle. Such lifecycle management operations are written as monolithic pieces of software code that are specific to the programming model and deployment requirements of an application that is deployed and runtime specifics of the application server platform. However, as applications evolve, as new programming models are introduced and adopted, and as more features are added to applications, the corresponding lifecycle management operations should also improve. There is therefore an ongoing need in improvement in lifecycle management.

### SUMMARY OF THE INVENTION

Methods, systems, and computer program products are provided for dynamically creating and executing an application lifecycle management operation. Embodiments include receiving a packaged application for lifecycle management and an instruction to perform a lifecycle management operation; querying a plurality of plug-ins for steps to carry out a plurality of aspects of the management operation on the packaged application; receiving from one or more of the queried plug-ins steps to carry out a plurality of aspects of the management operation; and executing the steps.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for dynamically creating and executing an application lifecycle management operation according to embodiments of the present invention.

FIG. 2 sets forth a block diagram of automated computing machinery comprising an exemplary management server useful in dynamically creating and executing an application lifecycle management operation according to embodiments of the present invention.

FIG. 3 sets forth a flow chart illustrating an exemplary method for dynamically creating and executing an application lifecycle management operation.

FIG. 4 sets forth a flow chart illustrating another method for dynamically creating and executing a lifecycle management operation that includes phases.

FIG. 5 sets forth a block diagram of a specific example of the relationship between the phases and steps of a lifecycle management operation in accordance with the present invention.

### DETAILED DESCRIPTION OF EXEMPLARY EMBODIMENTS

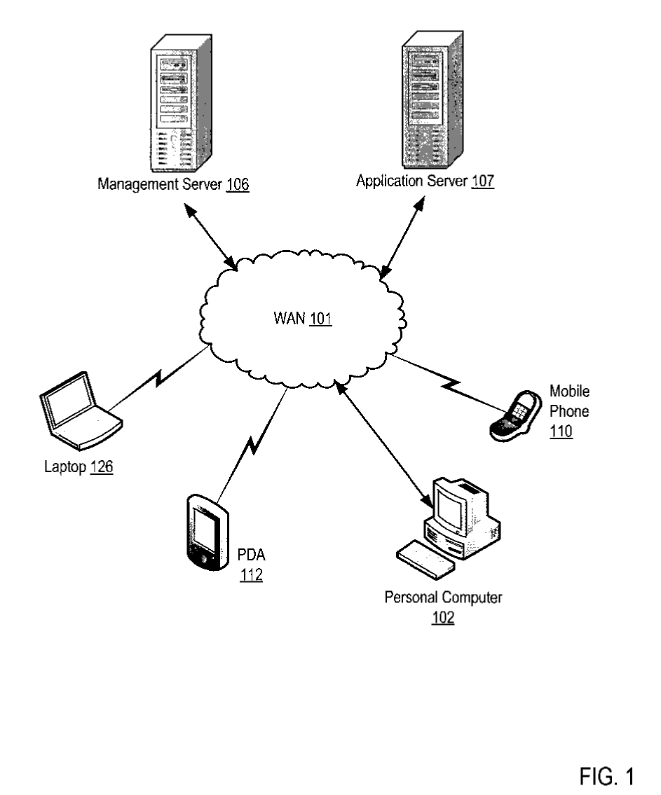

Exemplary methods, systems, and products for dynamically creating and executing an application lifecycle management operation according to embodiments of the present invention are described with reference to the accompanying drawings, beginning with FIG. 1. FIG. 1 sets forth a network diagram illustrating an exemplary system for dynamically creating and executing an application lifecycle management operation according to embodiments of the present invention. The system of FIG. 1 operates generally to dynamically create and execute an application lifecycle management operation according to embodiments of the present invention by receiving a packaged application for lifecycle management and an instruction to perform a lifecycle management operation; querying a plurality of plug-ins for steps to carry out a plurality of aspects of the management operation on the packaged application; receiving from one or more of the queried plug-ins steps to carry out a plurality of aspects of the management operation; and executing the steps.

The system of FIG. 1 includes an application server (107) providing a run-time environment for an application. An application is software such as business application or web application that may be deployed on and run on the application server (107). In the example of FIG. 1, an application deployed and running on the application server (107) may provide services accessible to users through a wide area network (‘WAN’) (101) and client applications running on one or more of the client devices such as the laptop (104), the personal digital assistant (‘PDA’) (106), the personal computer (108), and the mobile phone (110).

The system of FIG. 1 includes a management server (106) for lifecycle management of an application to be deployed on the application server (107) and capable of dynamically creating and executing an application lifecycle management operation according to the present invention. Lifecycle management of an application includes the processes included in making an application ready to run in a runtime environment, as well as those processes useful in maintaining the application over time. Lifecycle management includes the assembly, deployment, and maintenance of an application. Examples of lifecycle management operations include first time installation of an application, initial deployment of an application, editing of configurations of an application, starting an application, stopping an application, updating parts of an application, updating the entire application, exporting an application for backup, and so on as will occur to those of skill in the art. Often lifecycle management operations are programming model specific or runtime environment specific.

The execution of each lifecycle management operation often includes one or more steps carrying out a plurality of aspects of the lifecycle management operation. Such steps are lifecycle management operation specific, and therefore, often programming model or runtime environment specific. For example, an installation of an application may include steps for validating the input parameters and application contents, preprocessing the application with code generation to make the application ready for running on the server, configuring application attributes such as thread pool settings, security settings, and external references, and saving the application in the appropriate location for runtime logic to read the application, as well as others as will occur to those of skill in the art.

The management server (106) is capable of dynamically creating and executing an application lifecycle management operation by receiving a packaged application for lifecycle management and an instruction to perform a management operation; querying a plurality of plug-ins for steps to carry out a plurality of aspects of the management operation on the packaged application; receiving from one or more of the queried plug-ins steps to carry out a plurality of aspects of the management operation; and executing the steps.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

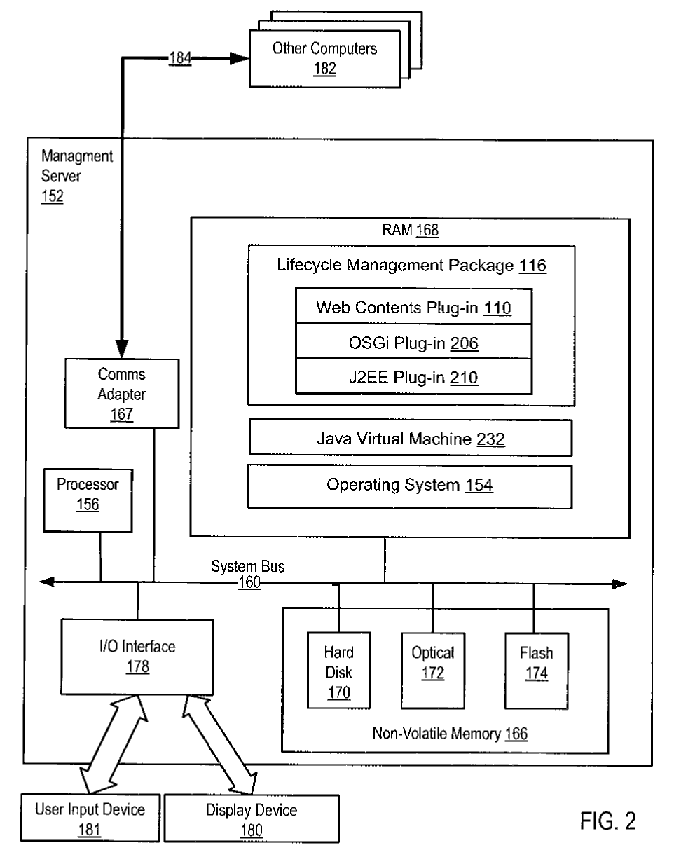

Dynamically creating and executing application lifecycle management operations in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary management server (152) useful in dynamically creating and executing an application lifecycle management operation according to embodiments of the present invention. The management server (152) of FIG. 2 includes at least one computer processor (156) or ‘CPU’ as well as random access memory (168) (‘RAM’) which is connected through a system bus (160) to processor (156) and to other components of the management server.

Stored in RAM (168) is an lifecycle management package (116), computer program instructions capable of dynamically creating and executing an application lifecycle management operation by receiving a packaged application for lifecycle management and an instruction to perform a lifecycle management operation; querying a plurality of plug-ins for steps to carry out a plurality of aspects of the management operation on the packaged application; receiving from one or more of the queried plug-ins steps to carry out a plurality of aspects of the management operation; and executing the steps.

Also stored RAM (168) are three type specific plug-ins for identifying steps to carry out aspects of a lifecycle management operation for specific contents of the application. The plug-ins of FIG. 2 includes web content plug-in (110), an OSGi plug-in (110), and a J2EE plug-in (210). The web contents plug-in (110) of FIG. 2 is capable of identifying a plurality of steps to carry out a plurality of aspects of the management operation on web contents of the packaged application.

The example of FIG. 2 includes an OSGi plug-in (206). The OSGi plug-in (206) of FIG. 2 is capable of identifying a plurality of steps to carry out a plurality of aspects of the management operation on the OSGi specific contents of the packaged application. “OSGi” refers to the Open Service Gateway initiative, an industry organization developing specifications delivery of service bundles, software middleware providing compliant data communications and services through services gateways. The OSGi specification is a Java based application layer framework that gives service providers, network operator device makers, and appliance manufacturer's vendor neutral application and device layer APIs and functions. OSGi works with a variety of networking technologies like Ethernet, Bluetooth, the ‘Home, Audio and Video Interoperability standard’ (HAVi), IEEE 1394, Universal Serial Bus (USB), WAP, X-10, Lon Works, HomePlug and various other networking technologies. The OSGi specification is available for free download from the OSGi website at www.osgi.org.

The example of FIG. 2 includes a J2EE plug-in (210). The J2EE plug-in (210) of FIG. 2 is capable of identifying a plurality of steps to carry out a plurality of aspects of the management operation on J2EE-specific contents of the packaged application. ‘J2EE’ refers to the Java 2 Platform Enterprise Edition that defines a standard for developing applications. The J2EE standard framework provides support for a number of distributed computer technologies and services.

The example of FIG. 2 includes a web contents plug-in (110), an OSGi plug in (206), and a J2EE plug-in (210) for explanation and not for limitation. In fact, any number of type specific plug-ins may be used for dynamically creating and executing an application lifecycle management operation according to the present invention and all such plug-ins are well within the scope of the present invention.

Also stored in RAM (168) is a Java Virtual Machine (‘JVM’) (232). A JVM is a platform-independent execution environment that converts Java bytecode into machine language and executes it.

Also stored in RAM (168) is an operating system (154). Operating systems useful in management servers according to embodiments of the present invention include UNIX™, Linux™, Microsoft XP™, AIX™, IBM's i5/OS™, and others as will occur to those of skill in the art. The operating system (154) and lifecycle management package in the example of FIG. 2 are shown in RAM (168), but many components of such software typically are stored in non-volatile memory (166) also.

The management server (152) of FIG. 2 also includes non-volatile computer memory (166) coupled through a system bus (160) to processor (156) and to other components of the management server (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example management server of FIG. 2 includes one or more input/output interface adapters (178). Input/output interface adapters in management servers implement user-oriented input/output through, for example, software drivers and computer hardware for controlling output to display devices (180) such as computer display screens, as well as user input from user input devices (181) such as keyboards and mice.

The exemplary management server (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for dynamically creating and executing an application lifecycle management operation according to embodiments of the present invention include modems for wired dial-up communications, Ethernet (IEEE 802.3) adapters for wired network communications, and 802.11b adapters for wireless network communications.

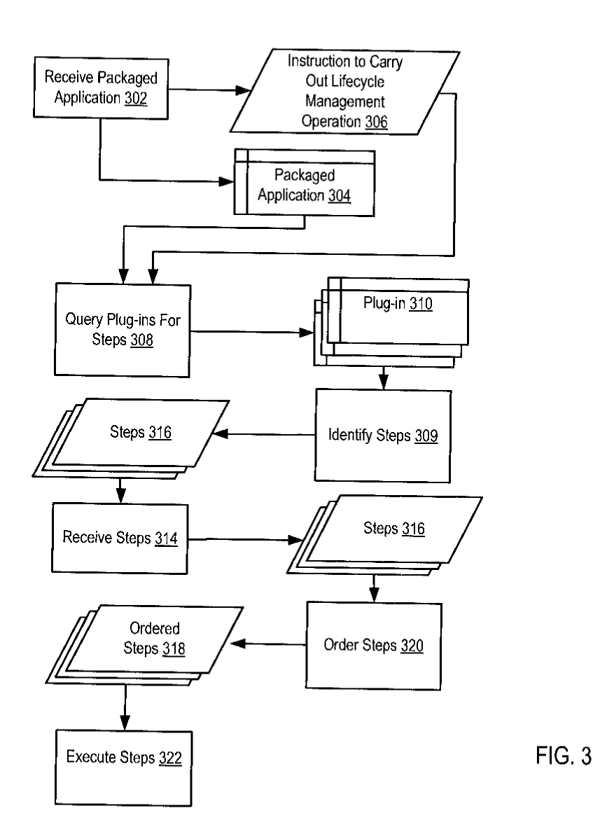

For further explanation, FIG. 3 sets forth a flow chart illustrating an exemplary method for dynamically creating and executing an application lifecycle management operation. As discussed above, lifecycle management of an application includes the processes included in making an application ready to run in a runtime environment, as well as those processes useful in maintaining the application over time. Lifecycle management includes the assembly, deployment, and maintenance of an application. Examples of lifecycle management operations include first time installation of an application, initial deployment of an application, editing of configurations of an application, staring an application, stopping an application, updating parts of an application, updating the entire application, exporting an application for backup, and so on as will occur to those of skill in the art. Often lifecycle management operations are programming model specific or runtime environment specific.

The execution of each lifecycle management operation often includes one or more steps carrying out a plurality of aspects of the lifecycle management operation. Such steps are lifecycle management operation specific, and therefore, often programming model or runtime environment specific. For example, an installation of an application may include steps for validating the input parameters and application contents, preprocessing the application with code generation to make the application ready for running on the server, configuring application attributes such as thread pool settings, security settings, and external references, and saving the application in the appropriate location for runtime logic to read the application, as well as others as will occur to those of skill in the art.

The method of FIG. 3 also includes receiving (302) a packaged application (304) for lifecycle management and an instruction (306) to perform a lifecycle management operation. A packaged application (304) is a collection of one or more modules which collectively contain the components of an application to be deployed. In the J2EE programming model, for example, an enterprise application archive, or (‘EAR’) file, includes a set of modules collectively containing all of the components of an application. The EAR file also contains a deployment descriptor, which specifies the modules that the EAR file contains and other application-wide configuration details.

The method of FIG. 3 also includes querying (308) a plurality of plug-ins (310) for steps to carry out a plurality of aspects of the management operation on the packaged application. Querying (308) a plurality of plug-ins (310) for steps to carry out a plurality of aspects of the management operation on the packaged application according to the method of FIG. 3 includes querying a plurality of plug-ins specifically designed to identify the specific steps to carry out the specific aspects of the particular lifecycle management operation on specific contents of the application. For example, a plug-in may be designed to identify the specific steps needed for installation of the OSGi contents of an application.

To query the proper plug-ins, dynamically creating and executing an application lifecycle management operation according to the method of FIG. 3 may include searching a plug-in registry for a plug in that support the specific lifecycle operation on the specific contents of the application. Plug-in may also be weighted to identify order and importance of plug-ins

The method of FIG. 3 includes identifying (309) by the plug-in a plurality of steps (316) to carry out a plurality of aspects of the management operation on contents of the packaged application. Identifying (309) by the plug-in a plurality of steps (316) to carry out a plurality of aspects of the management operation on contents of the packaged application according to the method of FIG. 3 includes identifying by the plug-in the specific steps for the specific lifecycle management operation for a specific category of the contents of the application. As just mentioned above, for example, a plug-in may be designed to identify the specific steps needed for installation of the OSGi contents of an application.

Identifying (309) by the plug-in a plurality of steps (316) to carry out a plurality of aspects of the management operation on contents of the packaged application according to the method of FIG. 3 may also include adding the steps to a list of steps shared among the plug-ins.

The method of FIG. 3 also includes receiving (314) from one or more of the queried plug-ins (310) steps (316) to carry out a plurality of aspects of the management operation, ordering (320) the steps, and executing (322) the steps (318) thereby carrying out at least a portion of the lifecycle management operation. Often the steps of a lifecycle management operation must be ordered prior to execution. That is, some steps must be performed before others. Ordering the steps prior to execution provides the proper execution sequence for carrying out the lifecycle management operation.

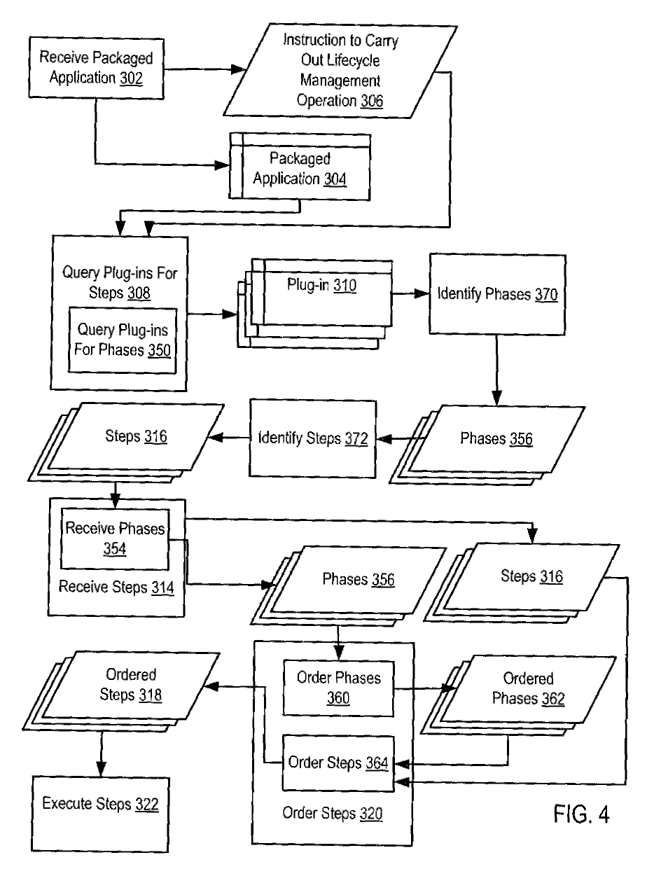

The specific order in which the steps returned by each of the plug-ins may be complex and may also fall into one or more general categories. That is, more than one plug-in designed to identify specific steps for carrying out a lifecycle management operation may have steps similarly situated in the execution sequence. For example, an OSGi plug-in and a J2EE plug-in may both be designed to identify steps for installation of the OSGi contents and the J2EE contents that are part of the general category of validation. For further explanation, therefore, FIG. 4 sets forth a flow chart illustrating another method for dynamically creating and executing a lifecycle management operation that includes phases. A phase is an ordered set of steps for carrying out an aspect of a lifecycle management operation all occurring within a particular sequence in the execution of the lifecycle management operation. That is, a lifecycle management operation may be carried out by set of phases defining the sequence and order of a plurality of sets of steps.

The method of FIG. 4 is similar to the method of FIG. 3 in that the method of FIG. 4 includes receiving (302) a packaged application (304) for lifecycle management and an instruction (306) to perform a lifecycle management operation; querying (308) a plurality of plug-ins (310) for steps to carry out a plurality of aspects of the management operation on the packaged application; identifying (309) by the plug-in a plurality of steps (316) to carry out a plurality of aspects of the management operation on contents of the packaged application; receiving (314) from one or more of the queried plug-ins (310) steps (316) to carry out a plurality of aspects of the management operation; ordering (320) the steps (316); and executing (322) the ordered steps (318).

The method of FIG. 4 differs from the method of FIG. 3, however, in that the method of FIG. 4, querying (308) a plurality of plug-ins (310) for steps (316) to carry out a plurality of aspects of the management operation on the packaged application includes querying (350) a plurality of plug-ins (310) for one or more phases associated with the steps. As discussed above, a phase is an ordered set of steps for carrying out an aspect of a lifecycle management operation all occurring within a particular sequence in the execution of the lifecycle management operation.

The method of FIG. 4 also includes identifying (370) by the plug-in one or more phases (356) to carry out a plurality of aspects of the management operation on contents of the packaged application and identifying (372) by the plug-in the steps (316) associated with the phases (356). Identifying (370) by the plug-in one or more phases (356) to carry out a plurality of aspects of the management operation on contents of the packaged application and identifying (372) by the plug-in the steps (316) associated with the phases (356) according to the method of FIG. 4 includes identifying one or more phases to carry out a plurality of aspects of the management operation on specific contents of the packaged application and identifying the specific steps associated with the specific phases. For example, a plug-in may be designed to identify the specific phases and associated steps need for installation of the OSGi contents of an application.

Identifying (370) by the plug-in one or more phases (356) to carry out a plurality of aspects of the management operation on contents of the packaged application may also include adding the phases to a list of phases shared among the plug-ins and identifying (372) by the plug-in the steps (316) associated with the phases (356) may include adding the steps to a list of steps shared among the plug-ins.

In the method of FIG. 4, receiving (314) from one or more of the queried plug-ins steps (316) to carry out a plurality of aspects of the management operation includes receiving (354) one or more phases (356) associated with the steps (316) and ordering (320) the steps includes ordering (360) the phases (356) and ordering (364) the steps (316) in dependence upon the ordered phases (362). Ordering the steps according to the phases provides an efficient vehicle for ordering the steps such that the ordered steps are executed in the proper sequence for carrying out the lifecycle management operation.

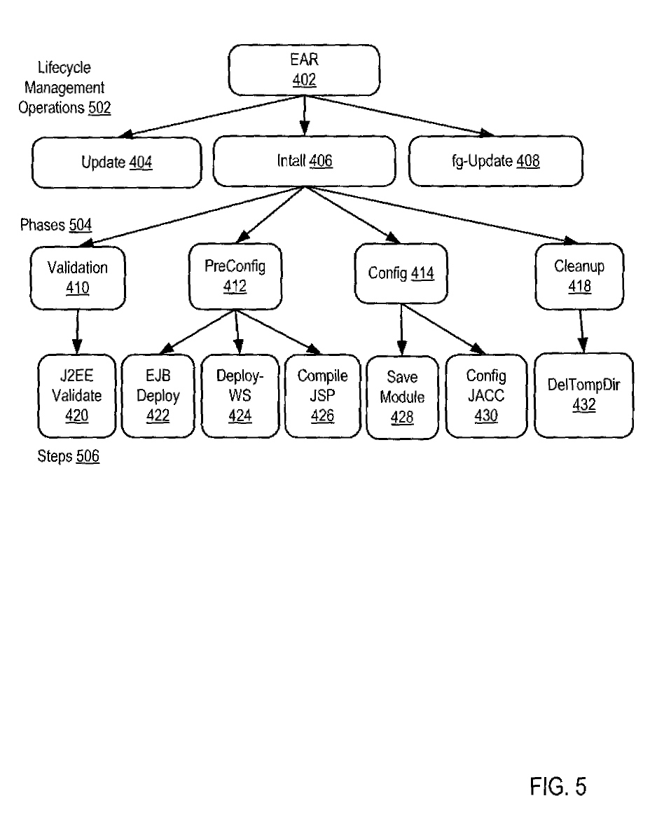

For further explanation, FIG. 5 sets forth a block diagram of a specific example of the relationship between the phases and steps of a lifecycle management operation in accordance with the present invention. The example of FIG. 5 includes three lifecycle management operations (502) for lifecycle management of an application contained in an EAR file (402). The three exemplary lifecycle management operations (502) of FIG. 5 include an update operation (404) for updating the application, an install operation (406) for installation of the application, and an fg-Update (408) operation for fine grained updating of specific modules or aspects of the application.

In the example of FIG. 5, executing the install operation (406) of the contents of the application includes four phases (504). The four phases of the install operation (406) include validation (410), pre-configuration (412), configuration (414), and cleanup (418). The exemplary validation (410) phase includes a single step (506) of J2EE validate (420) for validating the input parameters and application contents specific to J2EE contents of the application.

The exemplary pre-configuration phase (412) of the install operation (406) of FIG. 5 includes three steps (506). The three steps (506) of the pre-configuration phase (412) of the install operation (406) of FIG. 5 includes an EJB deploy step (422) for deploying Enterprise JavaBeans (‘EJB’) contents of the application, a Deploy-WS step (424) for deploying web services contents of the application, and a compile JSP step (426) for compiling Java Server Pages.

The exemplary configuration phase (414) of the install operation (406) of FIG. 5 includes two steps (506). The two steps (506) of the exemplary configuration phase (414) of the install operation (406) of FIG. 5 includes a save module step (428) for saving modules of the application, and a configJACC step (430) for configuring security permissions according to the Java Authorization Contract for Containers (Java ACC) specification.

The exemplary cleanup phase (414) of the install operation (406) of FIG. 5 includes a single DelTempDir step (432). The DelTempDir step (432) of the clean up phase (414) deletes temporary directories used in the install operation (406). The exemplary relationship between the phases and steps of the lifecycle management operation of FIG. 5 is presented for explanation and not for limitation. In fact, dynamically creating and executing an application lifecycle management operation according to the present invention may be used to carry out many different lifecycle management operations implemented through many different phases having many different steps and all such phases and steps are well within the present invention.

Dynamically creating and executing an application lifecycle management operation according to the present invention provides:
extensibility through plug-ins which may be created using new programming models and improvements to existing programming models.
flexibility to support lifecycle management of applications having components created according to different programming models
flexibility to define and enhance definition of lifecycle management operations based on contents and supported functionality from application deployment platform
   and other benefits as will occur to those of skill in the art.

Exemplary embodiments of the present invention are described largely in the context of a fully functional computer system for dynamically creating and executing an application lifecycle management operation. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for dynamically creating and executing an application lifecycle management operation, the method comprising:
receiving a packaged application for lifecycle management and an instruction to perform a lifecycle management operation;
querying a plurality of plug-ins for steps to carry out a plurality of aspects of the management operation on the packaged application;
receiving from one or more of the queried plug-ins steps to carry out a plurality of aspects of the management operation; and
executing the steps.

2. The method of claim 1 further comprising identifying by the plug-in a plurality of steps to carry out a plurality of aspects of the management operation on contents of the packaged application.

3. The method of claim 1 wherein querying a plurality of plug-ins for steps to carry out a plurality of aspects of the management operation on the packaged application further comprises querying a plurality of plug-ins for one or more phases associated with the steps; and
receiving from one or more of the queried plug-ins steps to carry out a plurality of aspects of the management operation further comprises receiving one or more phases associated with the steps.

4. The method of FIG. 3 further comprising identifying by the plug-in one or more phases to carry out a plurality of aspects of the management operation on contents of the packaged application; and
identifying by the plug-in the steps associated with the phases.

5. The method of claim 3 further comprising ordering the phases.

6. The method of claim 5 further comprising ordering the steps in dependence upon the ordered phases.

7. The method of claim 1 further comprising ordering the steps.

8. A system for dynamically creating and executing an application lifecycle management operation, the system comprising:
a computer processor;
a computer memory operatively coupled to the computer processor, the computer memory having disposed within it computer program instructions capable of:
receiving a packaged application for lifecycle management and an instruction to perform a lifecycle management operation;
querying a plurality of plug-ins for steps to carry out a plurality of aspects of the management operation on the packaged application; and
receiving from one or more of the queried plug-ins steps to carry out a plurality of aspects of the management operation; and
executing the steps.

9. The system of claim 8 wherein the computer memory also has disposed within it computer program instructions capable of identifying a plurality of steps to carry out a plurality of aspects of the management operation on contents of the packaged application.

10. The system of claim 8 wherein computer program instructions capable of querying a plurality of plug-ins for steps to carry out a plurality of aspects of the management operation on the packaged application further comprise computer program instructions capable of querying a plurality of plug-ins for one or more phases associated with the steps; and
computer program instructions capable of receiving from one or more of the queried plug-ins steps to carry out a plurality of aspects of the management operation further comprise computer program instructions capable of receiving one or more phases associated with the steps.

11. The system of claim 10 wherein the computer memory also has disposed within it computer program instructions capable of ordering the phases and computer program instructions capable of further comprising ordering the steps in dependence upon the ordered phases.

12. The system of claim 8 wherein the computer memory also has disposed within it computer program instructions capable of ordering the steps.

13. A computer program product embodied on a computer-readable medium, the computer program product comprising:
computer program instructions for receiving a packaged application for lifecycle management and an instruction to perform a lifecycle management operation;
computer program instructions for querying a plurality of plug-ins for steps to carry out a plurality of aspects of the management operation on the packaged application;
computer program instructions for receiving from one or more of the queried plug-ins steps to carry out a plurality of aspects of the management operation; and
computer program instructions for executing the steps.

14. The computer program product of claim 13 wherein computer program instructions for querying a plurality of plug-ins for steps to carry out a plurality of aspects of the management operation on the packaged application further comprise querying a plurality of plug-ins for one or more phases associated with the steps; and
computer program instructions for receiving from one or more of the queried plug-ins steps to carry out a plurality of aspects of the management operation further comprise computer program instructions for receiving one or more phases associated with the steps.

15. The computer program product of claim 14 further comprising computer program instructions for ordering the phases; and
computer program instructions for ordering the steps in dependence upon the ordered phases.

16. The computer program product of claim 13 further comprising computer program instructions for ordering the steps.

17. The computer program product of claim 13 wherein the computer-readable medium comprises a recordable medium.

18. The computer program product of claim 13 wherein the computer-readable medium comprises a transmission medium.
